(19) United States
(12) Patent Application Publication
(10) Pub. No.: US 2001/0020897 A1
(43) Pub. Date: Sep. 13, 2001

(54) Tag IC

(75) Inventors: Sunao Takatori, Tokyo (JP); Guoliang Shou, Tokyo (JP)

Correspondence Address: DARBY & DARBY P.C., 805 Third Avenue, New York, NY, 10022, US

(73) Assignee: YOZAN INC.

(21) Appl. No.: 09/799,422

(22) Filed: Mar. 5, 2001

(30) Foreign Application Priority Data
Mar. 9, 2000 (JP) 65020/2000

(51) Int. Cl. H04Q 5/22; G08B 13/14; G08B 23/00

(52) U.S. Cl. 340/572.7; 340/572.8; 340/10.1; 340/693.1

(57) ABSTRACT

There is provided a tag IC that radio waves transmitted from the tag IC is intensified, so that information stored in the tag IC can be read even if the distance between the tag IC and a reader is increased. The tag IC comprises an antenna that receives/transmits signals from/to the reader with AC electromagnetic energy, an IC chip that decodes received data from the reader, calculates transmitting data based on stored data, and transmits data, and a solar cell that directly converts optical energy to electrical energy to supply power to the IC chip.

### BACKGROUND OF THE INVENTION

1. Field of the Invention

The present invention relates to a noncontact type information medium, and more particularly to a tag IC used in a noncontact IC card that receives and transmits signals in a noncontact condition by an electromagnetic coupling system without providing an electrical contact to the IC card, which is employed in the field of Office Automation (OA), Factory Automation (FA), Security, and the like.

2. Description of the Related Art

Since the debut of an IC card having a semiconductor memory and the like built-in, the storage capacity has been dramatically increased as compared with the conventional magnetic card. A semiconductor processor such as a microcomputer has been built-in, so that the IC card itself has an arithmetic processing function. This has made it possible to impart high security to an information medium.

In general, the IC card has an IC such as a semiconductor memory built in a card main body made of plastic and the like, and a conductive terminal for connecting to an external reading and writing apparatus (hereinafter referred to as reader/writer) on the card surface.

However, in the IC card with the external connection terminal, since the terminal is exposed to the outside, a loose connection occurs because of dirt at the contact portion of the terminal, oxidization, corrosion, breakage, and soon. Moreover, when static electricity is charged on a human body or the card and is discharged by the contact between the human body and the contact terminal, the IC built in the card is broken or a high voltage is erroneously applied to the connection terminal, so as to damage the IC. The conventional IC card, however, takes no measures against such trouble.

Moreover, in order to perform data communication between the IC card and the external reader/writer, there is complexity in that the IC card must be inserted into the apparatus. Accordingly, if the complexity is the same as that of the magnetic card, the magnetic card is enough to use and this causes hesitation in introducing the IC card to the gate management for railway ticket and the like, management for clocking on and off at work, and so on.

In order to solve these problems, there is proposed such a noncontact tag IC that transmits an identification signal to an information processing circuit such as a microcomputer via a coupler such a coil, a capacitor, and the like. The tag IC increases security, and card wearers have only to approach an installed reader at the time of passing the gate. This results in a reduction in complexity for data communication.

As means for supplying power to the aforementioned noncontact tag IC, many methods for converting received energy to power are adopted and various kinds of coupling systems are proposed. Among these, there are a capacity coupling system and a magnetic coupling system as a coupling system for practical utilization. In the capacity coupling system using a capacitor, energy transmission efficiency is not high and a change in capacity is caused by a change in the distance between the tag IC and the reader, so that reliability of communication is low. Accordingly, the use of the magnetic coupling system becomes the main stream.

The conventional tag IC, however, performs transmission of power and data by single spiral coils, so that transmission efficiency is low. This causes the problems as follows:

More specifically, when power transmitted from the reader/writer as a drive unit is insufficient or the distance between the coil for a tag IC and the coil for a reader/writer is large, accurate transmission is not carried out and the tag IC does not normally function.

In consideration of the above problems, it is an object of the present invention to provide a tag IC that intensifies radio waves transmitted from the tag IC, so that information stored in the tag IC can be read even if the distance between the tag IC and a reader is increased.

### SUMMARY OF THE INVENTION

According to the present invention, there is provided a tag IC comprising an antenna for receiving/transmitting signals from/to a reader with AC electromagnetic energy; an IC chip for decoding received data from a reader to calculate transmitting data based on stored data and to transmit data; and a solar cell for directly converting optical energy to electrical energy to supply power to the IC chip.

The antenna is formed of a spiral antenna element, and the solar cell is formed in clearance of the spiral antenna. This eliminates the need for providing an extra space for the solar cell, and makes it possible to use the space effectively.

Moreover, the solar cell and the IC chip are directly or indirectly superimposed on each other. This makes it possible to structure the tag IC with substantially the same size as that of the IC chip.

Furthermore, the provision of an auxiliary cell, which is charged by the solar cell to supply power to the IC chip, allows power to be supplied even when no light is shined on the cell.

This specification includes part or all of the contents as disclosed in the specification and/or drawings of Japanese patent application Ser. No. 65020/2000, which is a priority document of the present application.

### BRIEF DESCRIPTION OF THE DRAWINGS

These objects and other objects and advantages of the present invention will become more apparent upon reading of the following detailed description and the accompanying drawings in which:

FIG. 1 is a view illustrating the structure of a tag IC according to a first embodiment of the present invention;

FIG. 2 is a view illustrating the structure of a tag IC according to a second embodiment of the present invention;

FIG. 3 is a view illustrating the structure of a tag IC according to a third embodiment of the present invention;

FIG. 4 is a view illustrating the structure of a tag IC according to a fourth embodiment of the present invention;

FIG. 5 is a view illustrating the structure of a tag IC according to a fifth embodiment of the present invention; and

FIG. 6 is a view illustrating the structure of an antenna of the present invention.

### DESCRIPTION OF THE PREFERRED EMBODIMENTS

Preferred embodiments will be specifically explained with reference to the accompanying drawings.

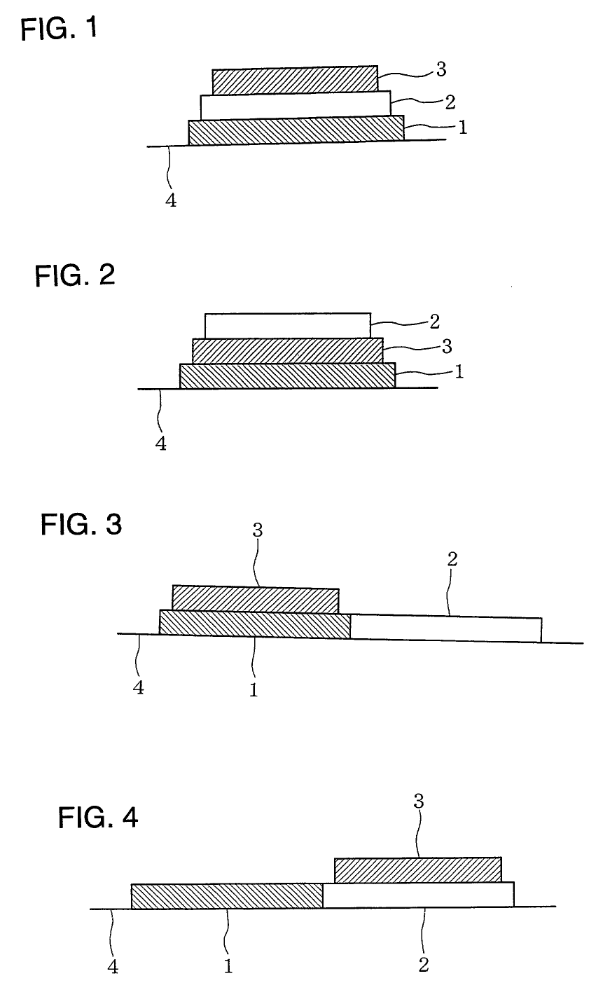

FIG. 1 is a view illustrating the structure of a tag IC according to a first embodiment of the present invention. This is the structure in which an IC chip 1 is placed on a sheet 4 and an antenna 2 and a solar cell 3 are superimposed thereon sequentially. In this case, the IC chip 1 and the solar cell 3 are indirectly superimposed on each other.

The IC chip 1 decodes received data from a reader (not shown), calculates transmitting data based on stored data, and transmits data. Data stored in the IC chip can be rewritten by the reader. A digital circuit and an analog circuit can be contained in the IC chip 1. The size of IC chip is, for example, 2.3 mm square. The antenna 2 has an antenna element 21, which is spirally formed as illustrated in FIG. 6. The antenna 2 is connected to an input/output terminal of the IC chip 1, and receives/transmits signals from/to the reader with AC electromagnetic energy. The solar cell 3 may be a known solar cell, which is an element for directly converting optical energy to electrical energy. A pn junction element, which is made of monocrystalline silicon, is mainly used, but polycrystalline silicon and amorphous silicon may be used for the purpose of reducing the manufacturing cost. The sheet 4 is a flexible sheet, and polyester film such as Mylar, which is a thermoplastic film, is suitable for the sheet 4.

Regarding the manufacturing method, the IC chip 1 is first prepared in a semiconductor manufacturing process and the antenna 2 is formed thereon with plating, and they are used as a substrate. The solar cell 3 is superimposed thereon. Moreover, they are adhered onto the sheet 4 as required. The manufacturing can be carried in a consistent process.

FIG. 2 is a view illustrating the structure of a tag IC according to a second embodiment of the present invention. This is the structure in which the IC chip 1 is placed on the sheet 4 and the solar cell 3 and the antenna 2 are superimposed thereon sequentially. In this case, the IC chip 1 and the solar cell 3 are directly superimposed on each other. In the second embodiment, the antenna element is made of a transparent conductive material or light is shined on the solar cell 3 from the clearance of the antenna element 21. Further, the antenna element 21 is provided at the center and the solar cell 3 may be placed around the antenna element 21. Or, the solar cell 3 is provided at the center and the antenna element 21 may be placed around the solar cell 3.

The manufacturing method is similar to the first embodiment. Namely, the IC chip 1 is first prepared in the semiconductor manufacturing process. The IC chip 1 is used as a substrate and the solar cell 3 is superimposed thereon. Then, the antenna 2 is formed thereon with plating. Moreover, they are adhered onto the sheet 4 as required.

FIG. 3 is a view illustrating the structure of a tag IC according to a third embodiment of the present invention. This is the structure in which the IC chip 1 is placed on the sheet 4 and the antenna 2 is placed thereon, and the solar cell 3 is superimposed on the IC chip 1.

Regarding the manufacturing method, the IC chip 1 is first prepared in the semiconductor manufacturing process. The IC chip 1 is used as a substrate and the solar cell 3 is superimposed thereon. Then, the IC chip 1 on which the solar cell 3 is superimposed and the antenna 2 are adhered onto the sheet 4 in line.

FIG. 4 is a view illustrating the structure of a tag IC according to a fourth embodiment of the present invention. This is the structure in which the IC chip 1 is placed on the sheet 4 and the antenna 2 is placed thereon, and the solar cell 3 is superimposed on the antenna 2.

Regarding the manufacturing method, the IC chip 1 is first prepared in the semiconductor manufacturing process. The antenna 2 is used as a substrate and the solar cell 3 is superimposed thereon. Then, the antenna 2 on which the solar cell 3 is superimposed and the IC chip 1 are adhered onto the sheet 4 in line.

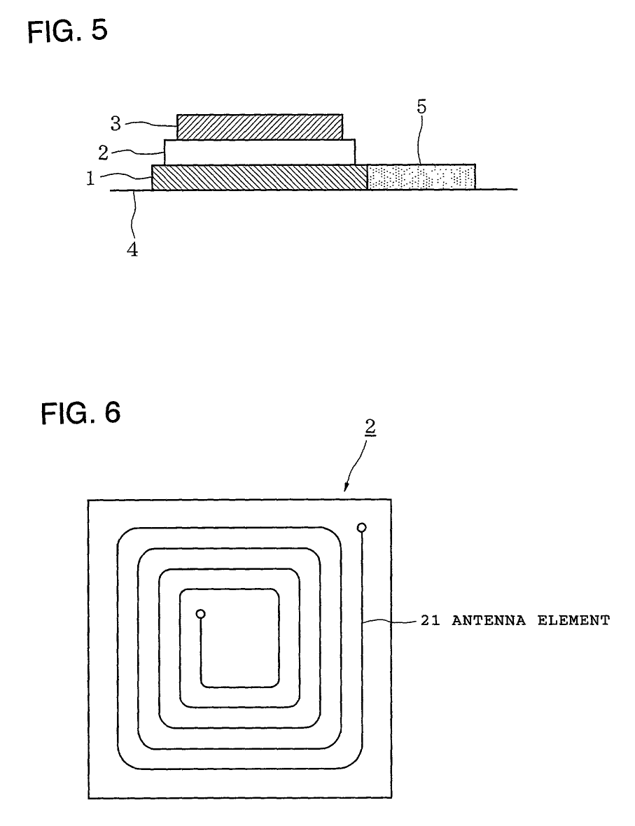

FIG. 5 is a view illustrating the structure of a tag IC according to a fifth embodiment of the present invention. An auxiliary cell 5, which is a secondary cell, is actually added to the first to fourth embodiments. FIG. 5 shows an example in which the auxiliary cell 5 is provided to the first embodiment. Regarding the other embodiments, the auxiliary cell 5 may be provided at an appropriate position. The auxiliary cell 5 is charged when light is shined thereon, making it possible to ensure necessary power even when no light is shined thereon.

It is noted that the present invention is not limited to the aforementioned embodiments.

Thus, according to the present invention, it is possible to read information stored in the tag IC even if the distance between the tag IC and the reader is increased.

Moreover, the use of solar cell eliminates the need for replacing the cell, and is suitable for a power source to the small device such as the tag IC.

Furthermore, the superimposing of the IC and the solar cell on each other makes it possible to implement the simple structure.

Various embodiments and changes may be made thereupon without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A tag IC comprising:
an antenna for receiving/transmitting signals from/to a reader with AC electromagnetic energy;
an IC chip for decoding received data from said reader to calculate transmitting data based on stored data and for transmitting data; and
a solar cell for directly converting optical energy to electrical energy to supply power to said IC chip.

2. The tag IC according to claim 1, wherein said antenna is formed of a spiral antenna element, and said solar cell is formed in clearance of said spiral antenna.

3. The tag IC according to claim 1, wherein said solar cell and said IC chip are directly or indirectly superimposed on each other.

4. The tag IC according to claim 1, wherein further comprising an auxiliary cell, which is charged by said solar cell, for supplying power to said IC chip.
